(19) United States
(12) Patent Application Publication
(10) Pub. No.: US 2014/0067577 A1
(43) Pub. Date: Mar. 6, 2014

(54) Content Gift Techniques

(71) Applicant: Nicholas Bradley Tucker, Redmond, WA (US)

(72) Inventor: Nicholas Bradley Tucker, Redmond, WA (US)

(73) Assignee: MICROSOFT CORPORATION, Redmond, WA (US)

(21) Appl. No.: 13/596,101

(22) Filed: Aug. 28, 2012

(51) Int. Cl. G06Q 30/06

(52) U.S. Cl. 705/26.1

(57) ABSTRACT

Content gift techniques are described. In one or more implementations, a service provider sends a notification for receipt by a computing device of a first user indicating availability of content as a gift from a second user, the content being transferrable via a network. Responsive to receipt of a response indicating acceptance of the content, an account associated with the second user is caused to be charged for the content by the service provider.

### BACKGROUND

Content, such as games and other applications, may be digitally distributed over a network rather than in a bricks-and-mortar store. This has caused the development of techniques to make the content available as gifts via the network. However, conventional techniques that are employed to gift this content can seem cold and impersonal.

For example, users of conventional gift techniques may be forced to give generic gift cards for a digital marketplace rather than gift a particular item of content. This may be due to restrictions imposed by the marketplace, such as restrictions on refunds of content that is to be provided as a gift. For example, conventional techniques may not support refunds for content that is already owned by a user that receives the content as a gift. Consequently, these restrictions imposed by the marketplace may reduce a willingness of the users to give content as gifts using conventional gift techniques.

### SUMMARY

Content gift techniques are described. In one or more implementations, a service provider sends a notification for receipt by a computing device of a first user indicating availability of content as a gift from a second user, the content being transferrable via a network. Responsive to receipt of a response indicating acceptance of the content, an account associated with the second user is caused to be charged for the content by the service provider.

In one or more implementations, a notification is received by a computing device of a first user indicating availability of content as a gift from a second user, the content being transferrable via a network by a service provider. An option is output as part of the notification by the computing device, the option selectable to cause the content to be exchangeable with other content by the service provider.

In one or more implementations, a system implemented by one or more computing devices is configured to perform operations that include receiving an indication from a first user of acceptance of content as a gift from a second user and transferring a license associated with the content to the first user from the second user responsive to the receiving of the indication.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to transmit content as a gift in accordance with one or more embodiments.

FIG. 2 is an illustration of a system in an example implementation showing the computing device of FIG. 1 in greater detail.

FIG. 3 is a flow diagram depicting a process in an example implementation in which a first user accepts content made available as a gift by a second user in accordance with one or more embodiments.

FIG. 4 is a flow diagram depicting a process in an example implementation in which a license to content is transferred upon acceptance of content by a first user in accordance with one or more embodiments.

FIG. 5 is a flow diagram depicting a process in an example implementation in which a first user rejects content made available as a gift by a second user in accordance with one or more embodiments.

FIG. 6 is a flow diagram depicting a process in which a first user exchanges content made available as a gift for other content.

FIG. 7 is a flow diagram depicting a process in which a gift is cancelled in accordance with one or more embodiments.

FIG. 8 illustrates an example system including various components of an example device that can be implemented as any type of computing device as described with reference to FIGS. 1 and 2 to implement embodiments of the techniques described herein.

### DETAILED DESCRIPTION

Overview

Conventional techniques to make content available as a gift are often inflexible. For example, these techniques may not support refunds, may make the process of accepting and/or actually obtaining the content difficult, and so on. Accordingly, users often chose to forgo use of these conventional techniques.

Content gift techniques are described herein. In one or more implementations, techniques are employed that may support increased flexibility in gifting of content from one user to another. For example, these techniques may be configured such that a user is not charged for a gift until that gift is accepted. Therefore, the use of refunds may be reduced and even eliminated, thereby improving efficiency of a service provider that employs these techniques.

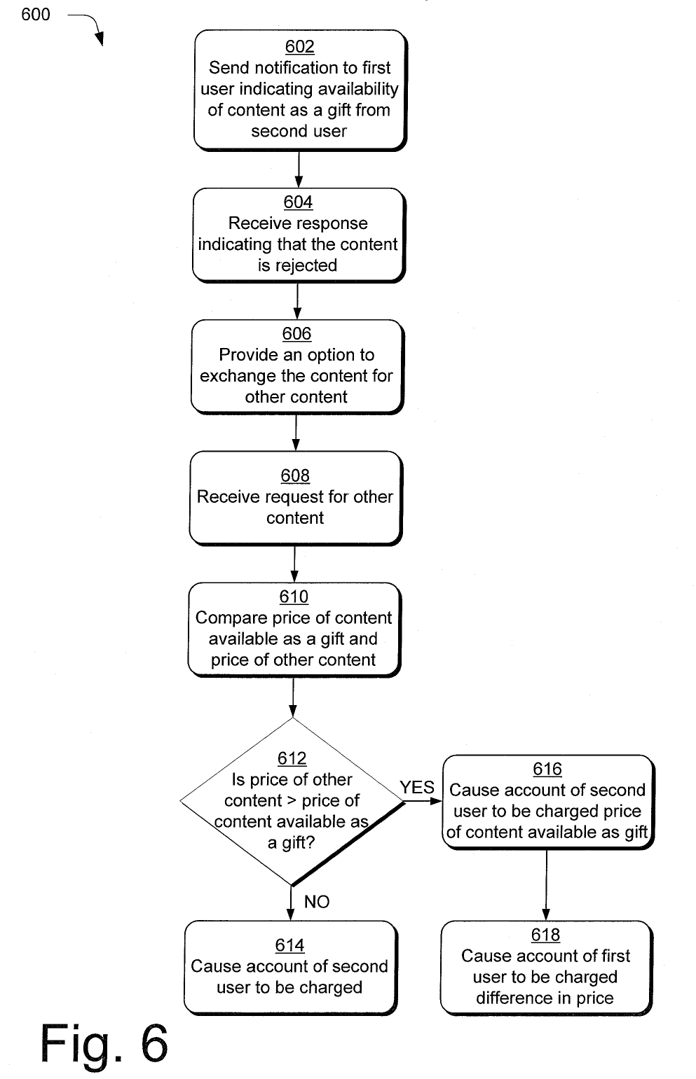

Additionally, techniques may be employed to allow a user to exchange content that is provided as a gift with other content of a service provider. For instance, a user may receive a notification of a gift of content from a service provider that is already owned by the user. In such an instance, this content may be exchanged with other content of the service provider that is selectable by the user. Thus, the user in this instance has an increased likelihood of obtaining content that is desirable to the user, further discussion of which may be found in relation to FIG. 6.

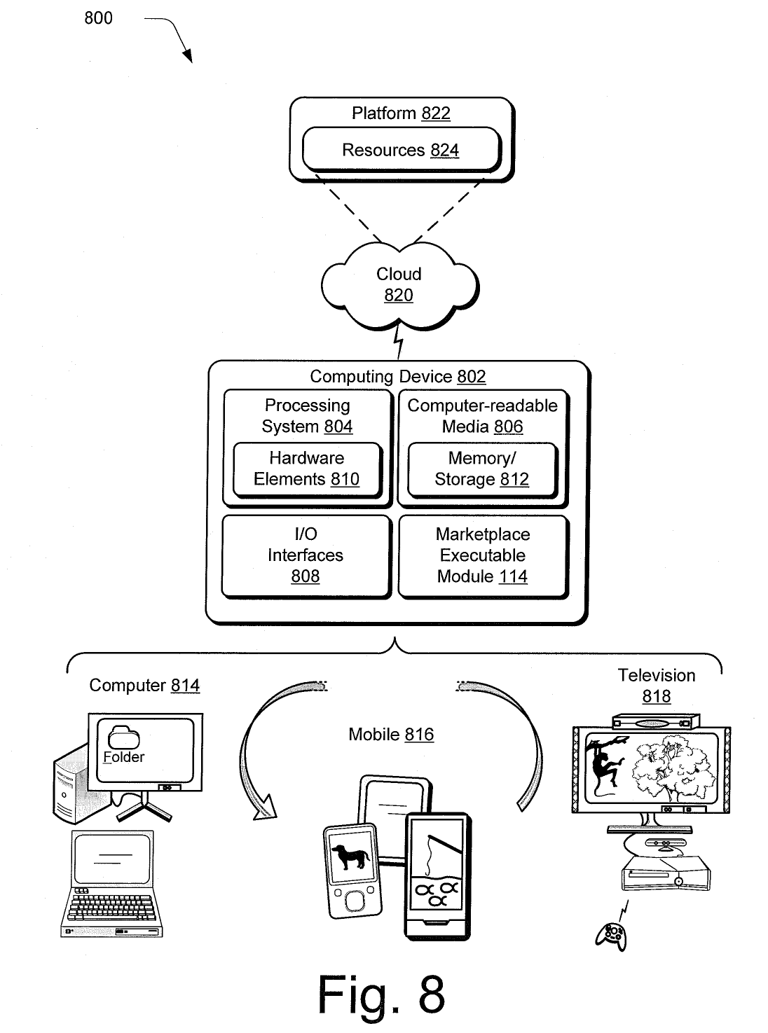

Further, techniques may be employed to support transfer of a license to content from one user to another. A first user, for instance, may have a license to an item of content, such as a song, video, book, application, and so forth. In this instance, the first user may transfer this license as a gift to a second user. As above, this transfer may be made upon acceptance of the content as the gift by the second user. In one or more implementations, the service provider may be configured to manage such transfers, such as to limit a number of transfers of the license. Further discussion of license transfer techniques may be found in relation to FIG. 8.

In the following discussion, an example environment is first described that may employ the content gift techniques described herein. Example procedures are then described which may be performed in the example environment as well as other environments. Consequently, performance of the example procedures is not limited to the example environment and the example environment is not limited to performance of the example procedures.

### Example Environment

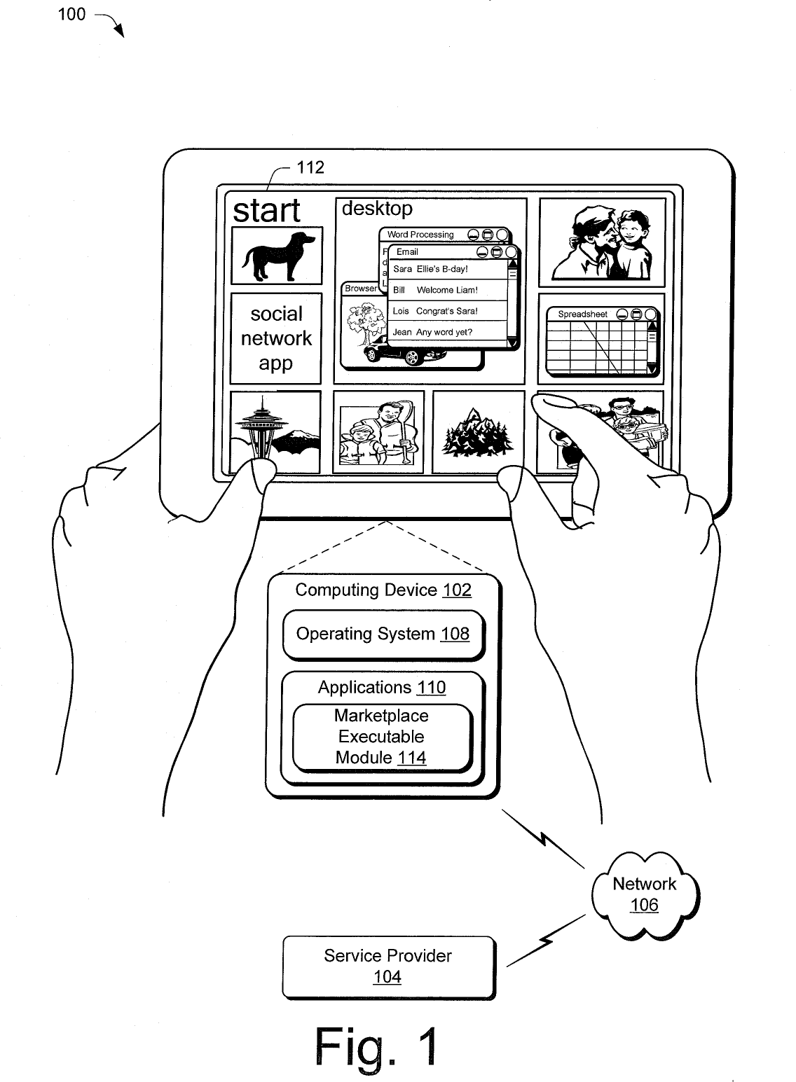

FIG. 1 is an illustration of an environment 100 in an example implementation that is operable to employ techniques described herein. The illustrated environment 100 includes a computing device 102 that is communicatively coupled to a service provider 104 via a network 106. The computing device 102, as well as computing devices that may implement the service provider 104, may be configured in a variety of ways.

For example, a computing device may be configured as a computer that is capable of communicating over the network 106, such as a desktop computer, a mobile station, an entertainment appliance, a set-top box communicatively coupled to a display device, a wireless phone, a game console, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as multiple servers utilized by a business to perform operations of the service provider 104, a remote control and set-top box combination, an image capture device and a game console configured to capture gestures, and so on.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be representative of multiple networks.

The computing device 102 is further illustrated as including an operating system 108. The operating system 108 is configured to abstract underlying functionality of the computing device 102 to applications 110 that are executable on the computing device 102. For example, the operating system 108 may abstract processing, memory, network, and/or display functionality of the computing device 102 such that the applications 110 may be written without knowing “how” this underlying functionality is implemented. The application 110, for instance, may provide data to the operating system 108 to be rendered and displayed by the display device 112 without understanding how this rendering will be performed. The operating system 108 may also represent a variety of other functionality, such as to manage a file system and user interface that is navigable by a user of the computing device 102. An example of this is illustrated as a desktop that is displayed on the display device 112 of the computing device 102.

As depicted in FIG. 1, applications 110 can include a marketplace executable module 114. Although illustrated as part of applications 110, it should be readily apparent that the functionality represented by this module may be implemented in a variety of other ways. For example, the functionality can be represented as a stand-alone application, as a third-party plugin, as part of the operating system 108, as part of a web platform, as part of a web-based application, and so forth.

The marketplace executable module 114 is representative of functionality to enable a user to browse for content, install content, and update or upgrade existing content. For example, a user may browse for and download new content, download new versions of content already on the computing device, and so forth. In another example, a user may select content to be provided as a gift to another user. Content can include audio, video, games, and other applications. In various embodiments, the content is downloadable, available via streaming, or otherwise digitally distributed.

The marketplace executable module 114 can be configured to enable a user to transmit a request to make content available as a gift to another user. The user transmitting the request can provide information regarding the intended recipients. In some embodiments, the provided information can be selected from a pre-populated list derived from the user's contacts or other identified connections, e.g., social network connections or the like. The intended recipient can be identified using an email address, a phone number, a gamer tag, or a login name of the recipient with the service provider.

The marketplace executable module 114 can also be configured to enable a user to receive a notification indicating availability of content as a gift from another user. The notification can include options to enable the user to accept the content, reject the content, or exchange the content for other content. In some embodiments, the option to exchange the content for other content is provided to the user responsive to the user indicating that the content is rejected.

The marketplace executable module 114 is configured to receive notifications from, and send responses to, the service provider 104 via network 106. The service provider 104 can be implemented as a remote device or a cloud-based service provider, e.g., to support a content distribution service or an online marketplace.

In various embodiments, service provider 104 is configured to receive a request to make content available as a gift, send a notification indicating the availability of the content as a gift, and receive a response to the notification. When the received response indicates acceptance of the content, service provider 104 is configured to charge the account of the user that requested the gifting of the content. The service provider 104 may also be configured to cause the content to be transferred via a network.

Service provider 104 is also configured to maintain or have access to a database of user accounts. The database of user accounts can include one or more client identifiers for each user. A client identifier can assume a variety of configurations, such as an email address, a phone number, a gamer tag, a login name, or a real name for the user. The database can also include information regarding a user's registered devices and/or content registered to the user. Service provider 104 can match or look up a client identifier included in a request to make content available as a gift and identify a user account associated with the client identifier. The service provider 104 can then send a notification for receipt by a computing device associated with the user account.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware of the computing device 102 to perform operations, e.g., processors, functional blocks, and so on. For example, the computing device 102 may include a computer-readable medium that may be configured to maintain instructions that cause the computing device, and more particularly hardware of the computing device 102, to perform operations. Thus, the instructions function to configure the hardware to perform the operations, and in this way, result in transformation of the hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

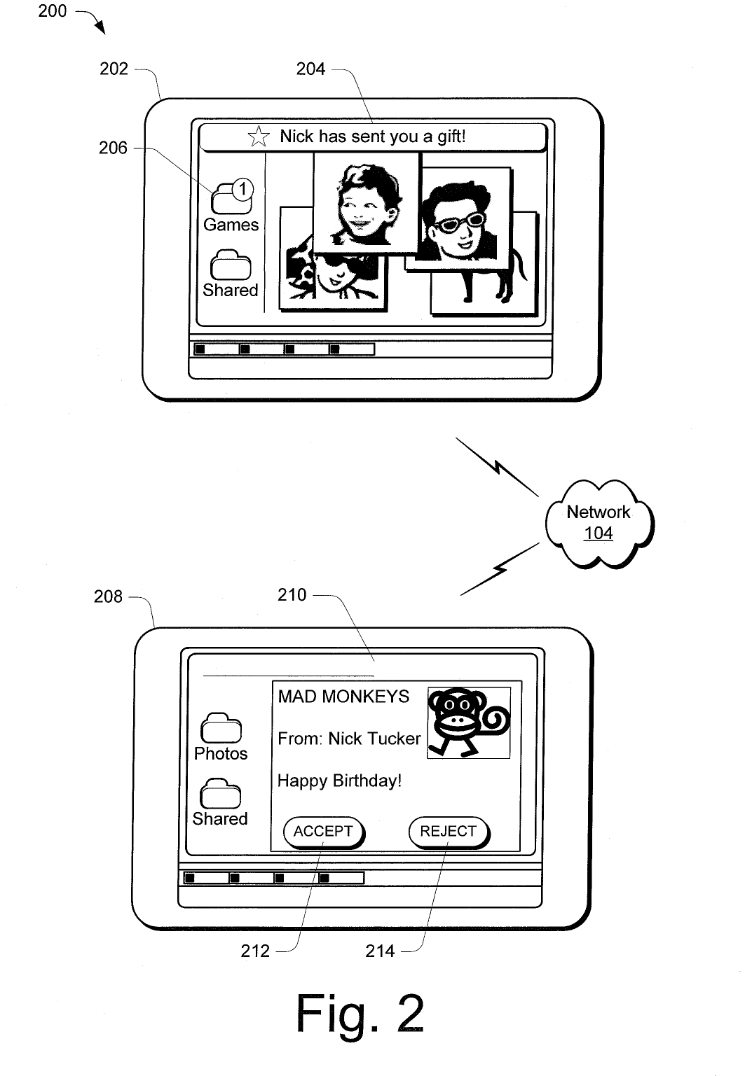

In FIG. 2, example system 200 includes a device 202 that is shown displaying an example notification 204 indicating the availability of content as a gift. The notification 204 can be displayed in a variety of ways. For example, the notification 204 can be displayed in a notification/status bar, in a notification window, in another notification area on the display, via a text message, via an email, via a notification icon displayed proximate to a second icon, or via a notification icon displayed at least partially overlapping a second icon. A notification icon 206, for instance, can be displayed near an icon that represents an application configured to communicate with the service provider.

In various embodiments, a user can provide a response to the notification by interacting with the notification displayed on the device. For example, the user can interact with the displayed notification and cause the marketplace executable module to be launched on the device. Interaction with the notification can cause additional information to be displayed regarding the content available as a gift.

In FIG. 2, a device 208 is also illustrated, which is shown as displaying additional information regarding the content. In particular, the user interface 210 displays information regarding the content and various options for responding to the notification. While the options shown include accept 212 and reject 214, other options are also contemplated. Additionally, in some embodiments, a message from the user that made the content available as a gift can be displayed.

The information displayed can also reference the user that made the content available as a gift, e.g., the sender. This may include information that identifies the sender. Further, the user's request may include how the sender is to be identified. For example, the user can indicate a desire to be identified by a gamer tag, a real name, a nickname, or another client identifier associated with the user's account.

Having described an example environment operable to employ content gift techniques, consider the following examples of content gift techniques.

### Example Processes

The following discussion describes content gift techniques that may be implemented utilizing the previously described systems and devices. Aspects of each of the processes may be implemented in hardware, firmware, software, or a combination thereof. The processes are shown as a set of blocks that specify operations performed by one or more devices and are not necessarily limited to the orders shown for performing the operations by the respective blocks. In portions of the following discussion, reference will be made to the environment 100 of FIG. 1.

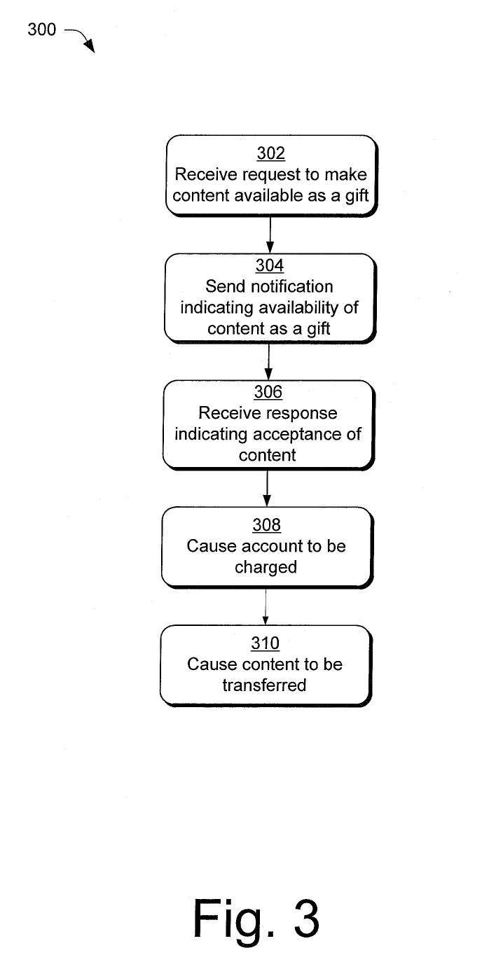

FIG. 3 is an example process 300 in which a first user accepts content made available as a gift by a second user. In at least some embodiments, process 300 can be implemented by a service provider 104 of FIG. 1.

The service provider 104 receives a request to make content available as a gift (block 302). The request can indicate a first user to whom the content is to be made available. As described above, the first user can be identified by a client identifier associated with the first user's account. In some embodiments, the request can indicate a plurality of users to whom the content is to be made available, e.g., multiple recipients. In such embodiments, identification of other users that also received the content as a gift may be hidden from a user.

The service provider 104 then sends a notification indicating the availability of the content as a gift to the first user (block 304). The service provider 104 may send the notification using information associated with the first user's account, e.g., email address, phone number, and so on. The notification can indicate that content has been made available by a second user, provide additional information regarding the content, and can provide response options for selection by the first user as described above. Response options can include, for example, an option to accept the content, an option to reject the content, and an option to exchange the content for other content.

In various embodiments, the request can also identify a time at which the notification is to be sent for receipt by the first user. For example, the request can indicate that the notification is to be sent on the first user's birthday, a holiday, or another point in time

Next, the service provider 104 receives a response indicating acceptance of the content (block 306). The acceptance can be received responsive to the first user selecting an “accept” option displayed as part of the sent notification. In various embodiments, a first user's response does not include a redemption code that is input and transmitted to the service provider in order to obtain the content. In this way, the first user may readily obtain the content without the disadvantages of conventional techniques as previously described above.

Responsive to receipt of the response, the service provider causes the account of the second user to be charged (block 308). Because the account of the second user is not charged until a response is received by the service provider 104 that indicates acceptance of the content, efficiency of the service provider may be improved. For example, use of this technique may reduce and even eliminate the use of refunds.

Additionally, upon processing payment, the service provider 104 can cause the content to be transferred via the network 106 (block 310). Causing the content to be transferred can include, by way of example and not limitation, causing the content to be downloaded to the first user's computing device 102, causing the content to be streamed to the first user's computing device 102, or causing a license to the content to be transferred to the first user. Transferring the license can include associating the license to the content to be associated with the first user's account.

In various embodiments, the content is installed on at least one computing device associated with the first user that did not receive the notification or form the response. For example, a user may receive a notification on a desktop computer and send an acceptance. The content can then be installed on the user's mobile device responsive to this acceptance.

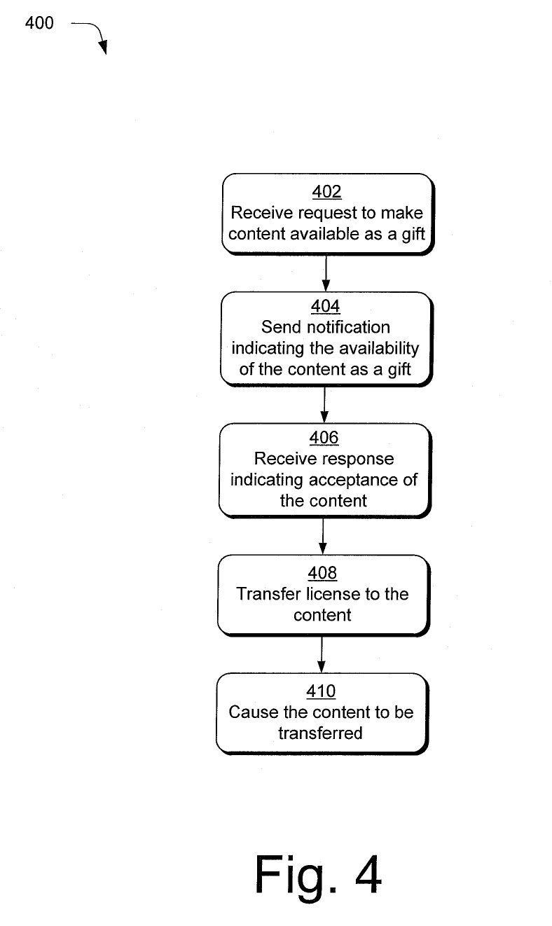

FIG. 4 is another example process 400 in which a first user accepts content made available as a gift by a second user. However, rather than being newly purchased, the content is made available as a gift to a first user when a second user requests that a license to the content be transferred. In at least some embodiments, process 400 can be implemented by a service provider 104.

As previously described, the service provider 104 receives a request to make content available as a gift (block 402). The service provider 104 then sends a notification indicating the availability of the content as a gift to the first user (block 404) and receives a response indicating acceptance of the content (block 406).

Next, the service provider 104 can transfer the license to the content from the second user to the first user (block 408). For example, the service provider 104 can revoke a license to the content that is associated with the second user's account and associate the license with the first user's account. In some embodiments, the content can be automatically removed from one or more of the second user's computing devices when the license is transferred.

In various embodiments, transferring a license can include invalidation of an old license followed by generating a new license for the first user. In some embodiments, the service provider 104 can manage and/or track availability of the new license for the first user.

In various embodiments, the service provider 104 manages the transfers of the license such that the license is not transferrable more than a predefined number of times. The number of times a license is transferable may be determined by a publisher of the content or the service provider 104. The service provider 104 can then track the number of times the license is transferred and how many transfers remain. Other information regarding license transfers can also be tracked.

After the license is transferred, the service provider 104 can cause the content to be transferred to the computing device 102 of the first user (block 410) as previously described, which may include streaming, download, and so forth.

Both processes 300 and 400 have described techniques that can be employed when a first user accepts the content that is made available as a gift. Other techniques can also be employed when the user's response to the notification indicates a rejection of the content or a request to exchange the content for other content.

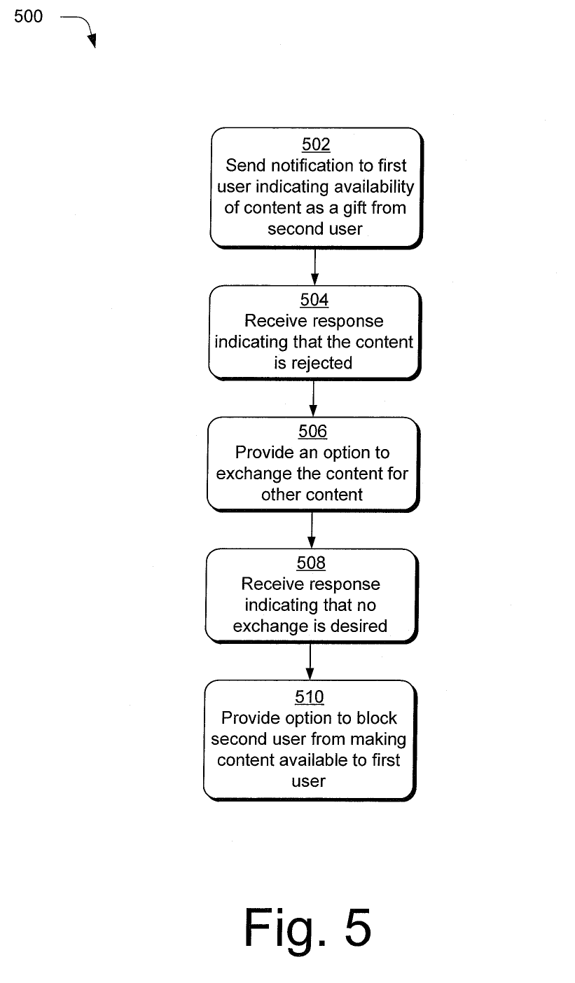

FIG. 5 is an example process 500 in which a first user rejects content made available as a gift by a second user. In at least some embodiments, process 500 can be implemented by a service provider 104.

The service provider 104 sends a notification indicating availability of content as a gift (block 502). The notification is sent to a first user's computing device 102 responsive to receipt of a request to make the content available as a gift from a second user.

Then, the service provider 104 receives a response indicating that the content is rejected (block 504). The service provider 104 then provides an option to exchange the content available as a gift for other content (block 506). The other content can be content selectable by the first user. Enabling the first user to select the content can result in an improved user experience. For example, the user can select content of interest to the user or content that the user might have desired rather than receiving content that the user does not desire to own or already owns.

The service provider 104 receives a response indicating that no exchange is desired (block 508), and provides an option to block the second user from making content available as a gift to the first user (block 510). The option to block the second user from making content available as a gift to the first user can also improve the user's experience. For example, the first user may not be burdened with notifications regarding gifts that the user does not intend to accept.

In various embodiments, the first user may block content made available as a gift from all other users, from one or more particular users, or from users making the content available to a particular client identifier of the first user. For example, a user can block content made available to the user as a gift using the user's gamer ID. The user could then still receive notifications regarding content made available to the user as a gift using the user's email address.

Content made available as a gift can also be rejected automatically and without user intervention. For example, parental controls associated with the user's account can indicate that the user is not permitted to receive content made available as a gift. In such instances, a notification can be sent to the second user upon receipt of the request to make the content available as a gift to the first user. As another example, the service provider 104 can determine that the computing device 102 of the first user is not compatible with the content to be made available as a gift. If the computing device 102 and the content are not compatible, the content may be automatically rejected. As yet another example, the service provider 104 can determine that the first user already owns the content to be made available as a gift. This determination can be made, for example, according to a review of the content associated with the first user's account. If the first user already owns the content, the content may be automatically rejected. In one embodiment, other options may be provided to the second user that has selected the content, such as to suggest other content for giving as a gift.

FIG. 6 is an example process 600 in which a first user exercises an option to exchange content made available as a gift for other content. The service provider 104 sends a notification indicating availability of content as a gift (block 602). The notification is sent to a first user's computing device 102 responsive to receiving a request to make the content available as a gift from a second user.

Then, the service provider 104 receives a response indicating that the content is rejected (block 604). The service provider 104 provides an option to exchange the content available as a gift for other content (block 606). The other content can be content selectable by the first user. The other content can be multiple content items.

Next, the service provider 104 receives a request for other content (block 608). The service provider 104 compares a price of the content available as a gift and a price of the other content (block 610) and determines if the price of the other content is greater than the price of the content available as a gift (block 612).

If the price of the other content is not greater than the price of the content available as a gift, the service provider 104 causes an account of the second user to be charged (block 614). The second user's account can be charged the price of the other content. Charging the second user's account the price of the other content can result in a monetary savings to the second user in instances where the user made more expensive content available as a gift to the first user. The second user can therefore enjoy savings without the hassle of requesting a refund for the difference in price.

If, however, the price of the other content is greater than the price of the content available as a gift, the service provider 104 may cause the second user's account to be charged the price of the content available as a gift (block 616). The service provider 104 then causes an account of the first user to be charged the difference in price (block 618). Such techniques enable a user to exchange content made available as a gift for other content, regardless of the price of the other content.

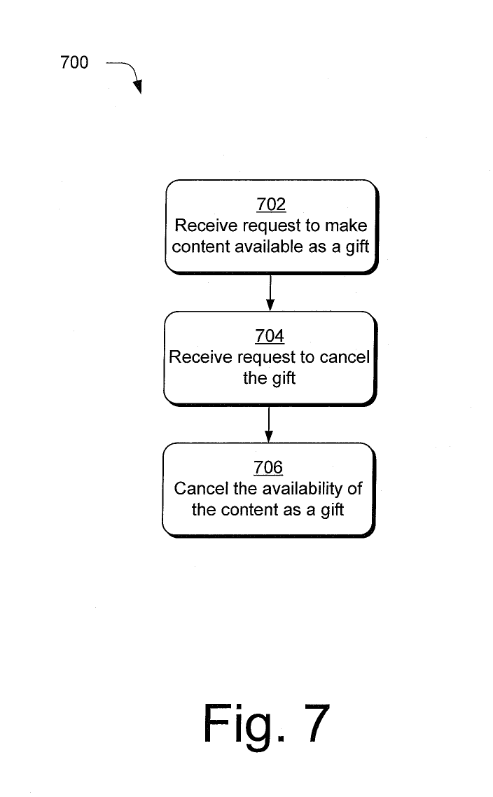

In various embodiments, after sending a request to make content available as a gift to a first user, a second user may decide that making the content available is no longer desirable. FIG. 7 is an example process 700 in which content made available as a gift is cancelled.

The service provider 104 receives a request to make content available to a first user as a gift from a second user (block 702). Then, the service provider 104 receives a request to cancel the gift from the second user (block 704). The service provider 104 may or may not have sent a notification indicating that content was available to the first user. Therefore, in such an instance the request to cancel the gift may be received from the second user before a response indicating acceptance of the content is received from the first user.

The service provider 104 may then cancels the availability of the content as a gift (block 706). In some embodiments, the service provider 104 may provide a notification that the content is no longer available as a gift to the first user. Other examples are also contemplated without departing from the spirit and scope thereof.

### Example System and Device

FIG. 8 illustrates an example system generally at 800 that includes an example computing device 802 that is representative of one or more computing systems and/or devices that may implement the various techniques described herein. This is illustrated through inclusion of the marketplace executable module 118, which as before may be executed on the computing device 802, as part of the platform 822 “over the cloud 820,” and so on. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. The computing device 802 also includes a marketplace executable module 118 that functions as described above. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer- readable storage media refers to non-signal bearing media. The computer- readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 802 may assume a variety of different configurations, such as for computer 814, mobile 816, and television 818 uses. Each of these configurations includes devices that may have generally different constructs and capabilities, and thus the computing device 802 may be configured according to one or more of the different device classes. For instance, the computing device 802 may be implemented as the computer 814 class of a device that includes a personal computer, desktop computer, a multi-screen computer, laptop computer, netbook, and so on.

The computing device 802 may also be implemented as the mobile 816 class of device that includes mobile devices, such as a mobile phone, portable music player, portable gaming device, a tablet computer, a multi-screen computer, and so on. The computing device 802 may also be implemented as the television 818 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. This functionality may also be implemented all or in part through use of a distributed system, such as over a “cloud” 820 via a platform 822 as described below.

The cloud 820 includes and/or is representative of a platform 822 for resources 824. The platform 822 abstracts underlying functionality of hardware (e.g., servers) and software resources of the cloud 820. The resources 824 may include applications and/or data that can be utilized while computer processing is executed on servers that are remote from the computing device 802. Resources 824 can also include services provided over the Internet and/or through a subscriber network, such as a cellular or Wi-Fi network.

The platform 822 may abstract resources and functions to connect the computing device 802 with other computing devices. The platform 822 may also serve to abstract scaling of resources to provide a corresponding level of scale to encountered demand for the resources 824 that are implemented via the platform 822. Accordingly, in an interconnected device embodiment, implementation of functionality described herein may be distributed throughout the system 800. For example, the functionality may be implemented in part on the computing device 802 as well as via the platform 822 that abstracts the functionality of the cloud 820.

### Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
sending a notification, by one or more computing devices, for receipt by a first user's computing device, indicating availability of content as a second user's gift, the content being transferrable via a network; and
responsive to a receipt of a response indicating acceptance of the content by the one or more computing devices, causing an account associated with the second user to be charged for the content; and
responsive to a receipt of a request to cancel the gift of the content from the second user before receipt of the response indicating acceptance of the content from the first user, cancelling availability of the gift of the content to the first user.

2. The method as described in claim 1, wherein the response does not include a redemption code input by the first user.

3. (canceled)

4. The method as described in claim 1, wherein the causing is performed such that the content is installed on at least one computing device associated with the first user different from the computing device that received the notification or formed the response.

5. The method as described in claim 1, further comprising responsive to the receipt of the response indicating acceptance of the content, causing a license to the content that is associated with the second user to be transferred to the first user.

6. The method as described in claim 5, further comprising managing transfer of the license such that the license is not transferrable more than a predefined number of times.

7. The method as described in claim 1, wherein the notification includes an option to reject the content.

8. The method as described in claim 7, further comprising responsive to receipt of a response indicating that the content is rejected, providing an option to exchange the content for other content.

9. The method as described in claim 1, further comprising providing a notification to the second user indicating that the content is rejected based on one or more parental controls, the notification comprising an alternative gift;
wherein the notification indicating availability of content as a second user's gift comprises indicating the availability of the alternative gift.

10. (canceled)

11. The method as described in claim 1, wherein the sending is performed responsive to receipt of a request to make the content available as the gift from the second user.

12. The method as described in claim 11, wherein the request identifies the first user using an email address, phone number, gamer tag, or login name of the first user with the service provider.

13. The method as described in claim 11, wherein the request does not identify the first user using an email address or login name of the first user with the service provider.

14. The method as described in claim 11, wherein the request identifies a future time before which the notification should not be sent for receipt by the first user over the network.

15. The method as described in claim 11, wherein the request identifies a plurality of users that include the first user that are to receive the content as the gift.

16. The method as described in claim 1, further comprising responsive to receipt of a first user's request to block gifts from the second user, blocking the second user from making subsequent content available as a gift to the first user.

17. (canceled)

18. (canceled)

19. (canceled)

20. (canceled)

21. A system comprising:
one or more processors;
one or more computer-readable storage memories comprising computer-readable instructions which, when executed by the one or more processors, perform a method comprising:
sending a notification, for receipt by a first user's computing device, indicating the availability of content as a second user's gift, the content being transferrable via a network;
receiving a response indicating acceptance of the content; and
responsive to receipt of the response, causing an account associated with the second user to be charged for content; and
receiving a request from the first user to block gifts from the second user; and
responsive to receipt of the request, blocking the second user from making subsequent content available as a gift to the first user.

22. (canceled)

23. One or more computer-readable storage memories comprising computer-readable instructions which, when executed, perform a method comprising:
sending a notification, for receipt by a first user's computing device, indicating availability of content as a second user's gift, the content being transferrable via a network, the notification including:
an option to accept the content;
an option to reject the content; and
an option to exchange the content; and
responsive to receipt of a response indicating acceptance of the content, causing:
an account associated with the second user to be charged for the content; and
the content to be transferred via the network for installation; and
responsive to receipt of a response indicating exchange of the content, enabling selection at the first user's computing device of alternate content for exchange.

24. The one or more computer-readable storage memories of claim 23, wherein the sending is performed responsive to a receipt of a request to make the content available as the gift from the second user.

25. The method as described in claim 1, further comprising responsive to the receipt of the response indicating acceptance of the content, causing the content to be transferred via the network for installation.

26. The system of claim 21, the method further comprising:
responsive to processing payment, causing the content to be transferred via the network for installation.

27. The method as described in claim 1, wherein the notification includes an option to exchange the content for other content.
